(19) United States
(12) Patent Application Publication
(10) Pub. No.: US 2025/0065682 A1
(43) Pub. Date: Feb. 27, 2025

(54) VEHICLE BEHAVIOR CONTROL APPARATUS

(71) Applicant: TOYOTA JIDOSHA KABUSHIKI KAISHA, Toyota-shi (JP)

(72) Inventor: Hiroki FURUTA, Susono-shi (JP)

(73) Assignee: TOYOTA JIDOSHA KABUSHIKI KAISHA, Toyota-shi (JP)

(21) Appl. No.: 18/760,725

(22) Filed: Jul. 1, 2024

(30) Foreign Application Priority Data
Aug. 25, 2023 (JP) 2023-137101

(51) Int. Cl. B60G 17/016

(52) U.S. Cl. CPC B60G 17/0162; B60G 2400/0511; B60G 2400/104; B60G 2400/40

(57) ABSTRACT

A vehicle behavior control apparatus includes: a variable roll stiffness device configured to change roll stiffness of a first axle being one of a front axle and a rear axle and roll stiffness of a second axle being another of the front axle and the rear axle; and a controller. The controller is configured to control the variable roll stiffness device so as to increase the roll stiffness of the first axle in accordance with a lateral acceleration in at least a low acceleration range. The controller is also configured to execute a control process of controlling the variable roll stiffness device so as to increase the roll stiffness of the second axle when the lateral acceleration increases to a high acceleration range beyond the low acceleration range, or a vehicle stability control for reducing at least one of oversteer and understeer of the vehicle is abnormal.

### CROSS-REFERENCES TO RELATED APPLICATION

The present disclosure claims priority under 35 U.S.C. § 119 to Japanese Patent Application No. 2023-137101, filed on Aug. 25, 2023, which is incorporated herein by reference in its entirety.

### BACKGROUND

### Technical Field

The present disclosure relates to a vehicle behavior control apparatus.

### Background Art

JP 2023-051026 A discloses a roll control apparatus for a vehicle. This roll control apparatus increases control amounts of actuators on both sides of a first axle and a second axle so as to increase roll stiffness of the first axle and the second axle (i.e., a rear axle and a front axle) in accordance with an increase in a lateral acceleration. When the lateral acceleration increases to a high acceleration range beyond a low acceleration range, the roll control apparatus reduces a gain of the control amount of the actuator on the first axle side with respect to the lateral acceleration in accordance with an increase in the lateral acceleration such that a roll stiffness distribution ratio of the first axle does not exceed a predetermined value.

### SUMMARY

According to the technique described in JP 2023-051026 A, it is possible to reduce a bias in roll stiffness distribution in the high acceleration range and, as a result, reduce the occurrence of unintended oversteer or understeer. However, with the technique of lowering the gain for controlling the roll, a large roll may be likely to occur in the high acceleration range. Moreover, when the lateral acceleration is low but a vehicle stability control is abnormal, the bias in roll stiffness distribution may be a factor that makes it easy to cause unintended oversteer or understeer depending on, for example, road surface conditions.

The present disclosure has been made in view of the problem described above, and an object thereof is to provide a vehicle behavior control apparatus that can reduce a bias in roll stiffness distribution while reducing a large roll according to the lateral acceleration or taking into consideration the state of a vehicle stability control.

A vehicle behavior control apparatus according to the present disclosure includes a variable roll stiffness device and a controller. The variable roll stiffness device is configured to change roll stiffness of a first axle being one of a front axle and a rear axle of a vehicle and roll stiffness of a second axle being another of the front axle and the rear axle. The controller is configured to control the variable roll stiffness device so as to increase the roll stiffness of the first axle in accordance with a lateral acceleration acting on the vehicle in at least a low acceleration range of ranges of the lateral acceleration. The controller is also configured to execute a control process of controlling the variable roll stiffness device so as to increase the roll stiffness of the second axle when the lateral acceleration increases to a high acceleration range beyond the low acceleration range, or a vehicle stability control for reducing at least one of oversteer and understeer of the vehicle is abnormal.

According to the present disclosure, when the lateral acceleration increases to the high acceleration range beyond the low acceleration range, the bias in the roll stiffness distribution can be reduced without depending on the technique of lowering the roll control gain (that is, while the occurrence of a large roll according to the lateral acceleration is reduced). Also, according to the present disclosure, when the lateral acceleration is in the low acceleration range but the vehicle stability control is abnormal, unintended oversteer or understeer can be reduced because the bias in the roll stiffness distribution is reduced by the control process.

### BRIEF DESCRIPTION OF THE DRAWINGS

FIG. 1 is a diagram illustrating a configuration of a vehicle equipped with a behavior control apparatus according to an embodiment;

FIG. 2 is a diagram conceptually showing a basic configuration of vehicle roll control according to an embodiment;

FIG. 3 is a flowchart illustrating an example of processes related to the vehicle roll control including a control process according to an embodiment; and

FIG. 4 is a diagram used to describe a specific example EX3 of a distribution process.

### DETAILED DESCRIPTION

### 1. Vehicle Behavior Control Apparatus

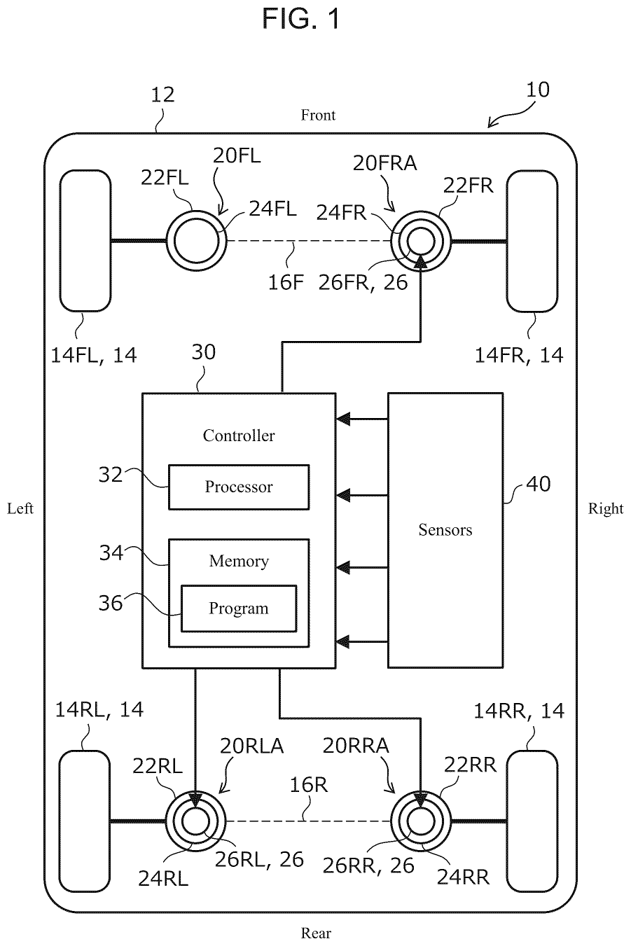

FIG. 1 is a diagram illustrating a configuration of a vehicle 10 equipped with a behavior control apparatus according to an embodiment. As shown in FIG. 1, the vehicle 10 has four wheels 14 including a left front wheel 14FL and a right front wheel 14FR on a front axle 16F, and a left rear wheel 14RL and a right rear wheel 14RR on a rear axle 16R. In the vehicle 10, for example, the left and right wheels 14FL and 14FR are steered wheels.

The vehicle 10 includes suspensions 20FL, 20FRA, 20RLA, and 20RRA. The suspensions 20FL, 20FRA, 20RLA, and 20RRA respectively suspend the left front wheel 14FL, the right front wheel 14FR, the left rear wheel 14RL, and the right rear wheel 14RR from a vehicle body 12.

The suspension 20FL of the left front wheel 14FL is a non-active suspension, and includes a spring 22FL and a shock absorber 24FL.

The suspension 20FRA of the right front wheel 14FR is an active suspension (more specifically, full active suspension), and includes an actuator 26FR in addition to a spring 22FR and a shock absorber 24FR. The actuator 26FR is configured to actively apply a control force in the vertical direction between the vehicle body 12 and the right front wheel 14FR. The actuator 26FR is, for example, electric or hydraulic.

The suspensions 20RLA and 20RRA for the rear axle 16R are also active suspensions. The suspensions 20RLA and 20RRA respectively include actuators 26RL and 26RR in addition to springs 22RL and 22RR and shock absorbers 24RL and 24RR. The actuators 26RL and 26RR are configured to actively apply control forces in the vertical direction between the vehicle body 12 and the left and right wheel 14RL and 14RR for the rear axle 16R, respectively. The actuators 26RL and 26RR are, for example, electric or hydraulic.

The vehicle 10 is equipped with a controller 30. The controller 30 is configured to acquire signals from sensors 40 mounted on the vehicle 10. The sensors 40 include sensors configured to measure physical quantities related to the behavior of the vehicle 10, such as one or more acceleration sensors, one or more vehicle height sensors, one or more sprung mass acceleration sensors, and one or more wheel speed sensors. The controller 30 is configured to control the actuators 26FR, 26RL, and 26RR.

The controller 30 includes a processor 32 and a memory 34 coupled to the processor 32. The processor 32 is configured to execute various processes related to a vehicle behavior control of the vehicle 10. The vehicle behavior control includes at least a vehicle roll control described below. The memory 34 is configured to store various kinds of information necessary for the processor 32 to execute the various processes. For example, the memory 34 stores a program 36 executable by the processor 32 and various kinds of information related to the program 36. The vehicle behavior control is realized by the processor 32 executing the program 36.

The various processes related to the vehicle behavior control of the vehicle 10 may include a process related to the following vehicle stability control. The vehicle stability control is control for reducing at least one of oversteer and understeer of the vehicle 10. The vehicle stability control includes, for example, controlling at least one of a drive device and a brake device of the vehicle 10 such that the controller 30 detects skidding of the vehicle 10 using the sensors 40 and reduces the skidding. The drive device is, for example, at least one of an electric motor and an internal combustion engine.

### 2. Vehicle Roll Control

In the present embodiment, the rear axle 16R corresponds to a “first axle”, and the front axle 16F corresponds to a “second axle”. The pair of left and right active suspensions 20RLA and 20RRA for the rear axle 16R and the single active suspension 20FRA for the front axle 16F function as a “variable roll stiffness device” that changes the roll stiffness of the rear axle 16R and the roll stiffness of the front axle 16F. Further, the “vehicle behavior control apparatus” according to the present embodiment includes the variable roll stiffness device and the controller 30. The vehicle roll control according to the present embodiment is executed by the controller 30 that controls the variable roll stiffness device.

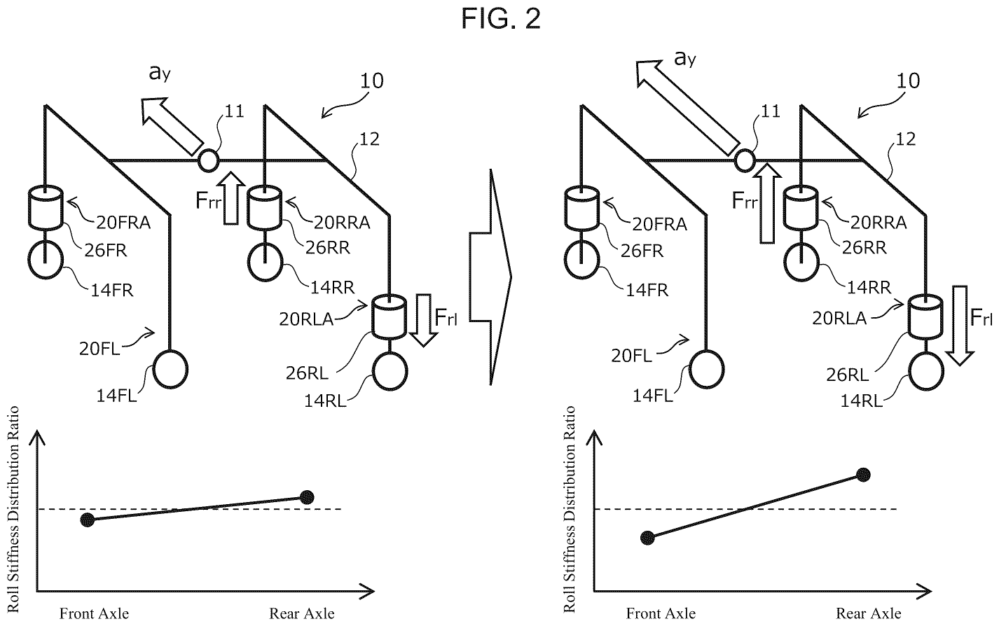

First, FIG. 2 is a diagram conceptually showing a basic configuration of the vehicle roll control according to the present embodiment. FIG. 2 shows a modeled vehicle 10, a lateral acceleration (i.e., lateral G) a_{y} acting on the gravity center 11 of the vehicle 10, and control forces Fᵣₗ and Fᵣᵣ for roll reduction that are applied by the variable roll stiffness device. The left side of FIG. 2 shows a state in which the lateral acceleration a_{y} is low, and the right side shows a state in which the lateral acceleration a_{y} is increased. Further, FIG. 2 shows a graph indicating changes in roll stiffness distribution ratios for the front axle 16F and the rear axle 16R before and after the lateral acceleration a_{y} increases.

The basic configuration of the vehicle roll control for the vehicle 10 having the suspension configuration shown in FIGS. 1 and 2 is as follows. That is, the control forces Fᵣₗ and Fᵣᵣ in opposite phases are generated by the actuators 26RL and 26RR on the side of the rear axle 16R provided with the active suspensions 20RLA and 20RRA on both the left and right wheels 14RL and 14RR. More specifically, when, for example, the lateral acceleration a_{y} in the right direction acts on the vehicle 10 as shown in FIG. 2, the control force Fᵣₗ in the downward direction is applied to the left rear wheel 14RL by the actuator 26RL, and the control force Fᵣᵣ in the upward direction is applied to the right rear wheel 14RR by the actuator 26RR. As a result, in the vehicle 10 having the suspension configuration described above, it is possible to generate a roll moment for reducing the roll caused by the lateral acceleration a_{y} without causing heave and pitching. In other words, the roll stiffness of the rear axle 16R (first axle) can be increased with respect to the lateral acceleration a_{y}.

Moreover, according to the basic configuration of the vehicle roll control, the control forces Fᵣₗ and Fᵣᵣ applied to the left and right wheels 14RL and 14RR are increased in accordance with the lateral acceleration a_{y} as will be described below in detail. That is, the variable roll stiffness device is controlled by the controller 30 so as to increase the roll stiffness of the rear axle 16R in accordance with an increase in the lateral acceleration a_{y}. In FIG. 2, the lengths of arrows indicating the direction of the lateral acceleration a_{y} indicate the magnitude of the lateral acceleration a_{y}. The lengths of arrows indicating the directions of the control forces Fᵣₗ and Fᵣᵣ indicate the magnitudes of the control forces Fᵣₗ and Fᵣᵣ, respectively.

According to the basic configuration of the vehicle roll control, as shown in FIG. 2, the roll stiffness distribution ratio for the rear axle 16R increases when the roll stiffness of the rear axle 16R increases in accordance with an increase in the lateral acceleration a_{y}. That is, the bias in the roll stiffness distribution ratio increases with an increase in the lateral acceleration a_{y}. This may lead to the occurrence of unintended oversteer or understeer when the vehicles turns with high lateral acceleration a_{y}. In this regard, by lowering a roll control gain in the high acceleration range, it is possible to reduce the occurrence of the unintended oversteer or understeer. However, according to this method, a large roll becomes likely to occur in the high acceleration range. Further, it is desirable that the measures for reducing the bias in the roll stiffness distribution are taken in consideration of the state of the vehicle stability control.

Accordingly, the processes executed by the controller 30 in relation to the vehicle roll control according to the present embodiment include a “control process”. In the control process, when the lateral acceleration a_{y} increases to a high acceleration range R2 beyond a low acceleration range R1 or when the vehicle stability control is abnormal, the controller 30 controls the “variable roll stiffness device” so as to increase the roll stiffness of the front axle 16F (second axle).

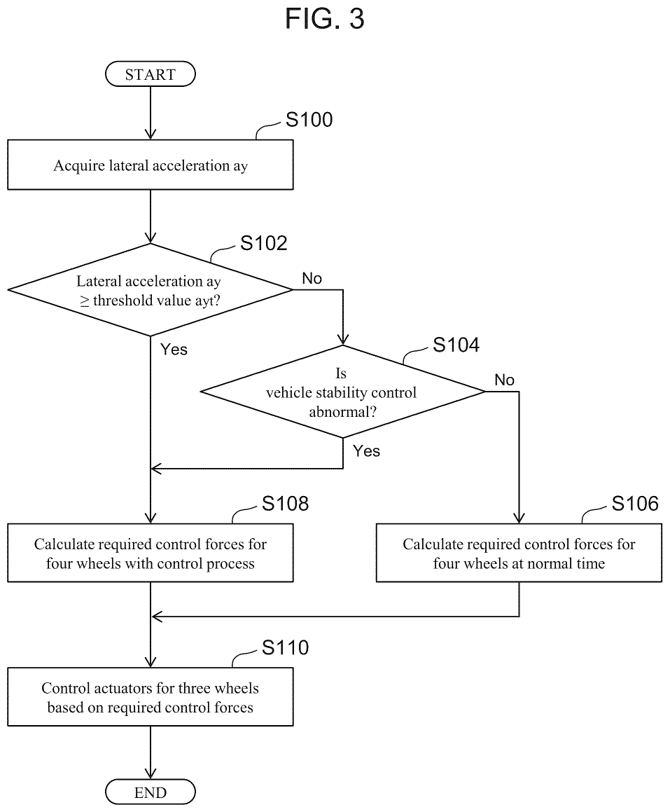

FIG. 3 is a flowchart illustrating an example of processes related to the vehicle roll control including the control process according to the present embodiment. The processes of this flowchart are repeatedly executed by the controller 30 (processor 32) while the vehicle 10 is traveling.

### <Step S100>

First, in step S100, the controller 30 acquires the lateral acceleration a_{y} using the sensors 40. Specifically, the lateral acceleration a_{y} is an estimated value acquired from, for example, the steering angle and the vehicle speed. However, the method of acquiring the lateral acceleration a_{y} is not particularly limited. The lateral acceleration a_{y} may be, for example, a sensor value measured by an acceleration sensor.

### <Step S102>

Then, in step S102, the controller 30 determines whether or not the lateral acceleration a_{y} acquired in step S100 is equal to or higher than a designated threshold value a_{yt}. That is, it is determined whether the lateral acceleration a_{y} is in the high acceleration range R2 or in the low acceleration range R1.

More specifically, the high acceleration range R2 corresponds to an acceleration range near the turning limit of the vehicle 10. Therefore, the lateral acceleration a_{y} being lower than the threshold value a_{yt} (i.e., being in the low acceleration range R1) means that there is a margin with respect to the turning limit. When there is this margin, unintended oversteer or understeer, or large roll does not occur. Therefore, in step S102, the degree of margin of the lateral acceleration a_{y} with respect to the turning limit is determined. For example, it is simply determined that, when the lateral acceleration a_{y} is equal to or higher than the threshold value a_{yt} (that is, in the high acceleration range R2), the degree of margin with respect to the turning limit is small. In addition, when an estimated friction coefficient of a road surface on which the vehicle 10 is traveling can be calculated, the threshold value a_{yt} may be determined in consideration of the estimated friction coefficient in order to determine the degree of margin with respect to a limit lateral acceleration according to the estimated friction coefficient.

### <Step S104>

When the lateral acceleration a_{y} is lower than the threshold value a_{yt} (step S102; No), the controller 30 determines in step S104 whether or not the vehicle stability control is abnormal. The technique of determining whether or not the vehicle stability control is abnormal is not particularly limited, and any known determination method may be used.

### <Step S106>

When the determination result in step S104 is No (that is, when the lateral acceleration a_{y} is lower than the threshold value a_{yt} and the vehicle stability control is normal), the processing proceeds to step S106. Hereinafter, the time when the processing proceeds to step S106 in this way is simply referred to as “normal time”.

In step S106, the controller 30 calculates required control forces F_{fli}, F_{fri}, Fᵣₗᵢ, and Fᵣᵣᵢ for the respective wheels 14 (i.e., the four wheels 14 including the left front wheel 14FL without the actuator 26) in the vehicle roll control for the normal time. The required control forces F_{fli}, F_{fri}, Fᵣₗᵢ, and Fᵣᵣᵢ are control forces required for the respective wheels 14 in order to realize a required roll moment Mᵣ.

The required roll moment Mᵣ is a roll moment required for reducing the roll behavior by the vehicle roll control, and is expressed by the following Equation 1. In Equation 1, α is a roll control gain, β1 is a feedback control gain (FB control gain) β for roll velocity of a sprung mass of the vehicle 10 (i.e., sprung mass roll velocity), ϕ is a roll angle, and s is a Laplace operator. The second term on the right side of Equation 1 represents a feedback term for the sprung mass roll velocity. By having this feedback term, the required roll moment Mᵣ corresponding to the lateral acceleration a_{y} can be calculated while the sprung mass roll velocity is brought close to a desired target value. It should be noted that the equation for calculating the required roll moment Mᵣ may have, for example, only the first term on the right side of Equation 1. That is, the required roll moment Mᵣ may be simply the product of the lateral acceleration a_{y} and the roll control gain α.

$${M}_{r} = α {a}_{y} + {β}_{1} φ s \qquad ( 1 )$$

The controller 30 calculates the required roll moment Mᵣ in accordance with Equation 1, and converts (distributes) the calculated required roll moment Mᵣ into the required control forces F_{fli}, F_{fri}, Fᵣₗᵢ, and Fᵣᵣᵢ for the four wheels 14 in accordance with the following Equation 2. In Equation 2, T_{f} is a front wheel tread, and Tᵣ is a rear wheel tread. The required control forces F_{fli}, F_{fri}, Fᵣₗᵢ and Fᵣᵣᵢ are positive when upward forces are required. The required roll moment Mᵣ is positive when a moment to lower the right side of the vehicle body 12 and lift the left side thereof is required.

$$[ \begin{matrix}{F}_{fli} \\ {F}_{fri} \\ {F}_{rli} \\ {F}_{rri}\end{matrix} ] = {M}_{r} [ \begin{matrix}1 / 2 {T}_{f} \\ - 1 / 2 {T}_{f} \\ 1 / 2 {T}_{r} \\ - 1 / 2 {T}_{r}\end{matrix} ] \qquad ( 2 )$$

### <Step S108>

When the lateral acceleration a_{y} is equal to or higher than the threshold value a_{yt} (step S102; Yes), or when the vehicle stability control is abnormal (step S104; Yes), the processing proceeds to step S108.

In step S108, the controller 30 calculates the required roll moment Mᵣ in accordance with the following Equation 3. Equation 3 is different from Equation 1 in the FB control gain β with respect to the sprung mass roll velocity. Specifically, in Equation 3, a value greater than the FB control gain β1 in Equation 1 is set as a FB control gain β2.

$${M}_{r} = α {a}_{y} + {β}_{2} φ s \qquad ( 3 )$$

In step S108, the controller 30 converts (distributes) the required roll moment Mᵣ into the required control forces F_{fli}, F_{fri}, Fᵣₗᵢ, and Fᵣᵣᵢ for the four wheels 14 in association with the control process described above. To be specific, the controller 30 calculates the required control forces F_{fli}, F_{fri}, Fᵣₗ and Fᵣᵣᵢ for the four wheels 14 by the following Equation 4. According to Equation 4, in comparison with Equation 2, the roll moment generated in the front axle 16F (second axle) for realizing the required roll moment Mᵣ is increased by an increase amount M_{rf}. In the example of the vehicle 10 shown in FIG. 1, the suspension 20FL for the left front wheel 14FL is a non-active suspension. Therefore, the increase amount M_{rf} is reflected in the required control force F_{fri} for the right front wheel 14FR having the actuator 26FR.

$$[ \begin{matrix}{F}_{fli} \\ {F}_{fri} \\ {F}_{rli} \\ {F}_{rri}\end{matrix} ] = [ \begin{matrix}{M}_{r} / 2 {T}_{f} \\ - ( {M}_{r} + {M}_{rf} ) / 2 {T}_{f} \\ ( {M}_{r} - {M}_{rrl} ) / 2 {T}_{r} \\ - ( {M}_{r} - {M}_{rrr} ) / 2 {T}_{r}\end{matrix} ] \qquad ( 4 )$$

The controller 30 determines the increase amount M_{rf} such that the bias in the roll stiffness distribution is reduced. To be specific, the controller 30 determines the increase amount M_{rf} by the following method, for example. That is, the controller 30 calculates the increase amount M_{rf} in accordance with the following Equation 5 when the lateral acceleration a_{y} is equal to or higher than the threshold value a_{yt}. In Equation 5, γ is a designated gain. By using Equation 5, when the lateral acceleration a_{y} increases in the high acceleration range R2 (that is, when the lateral acceleration a_{y} approaches the turning limit), the roll moment generated on the side of the front axle 16F increases. In other words, when the lateral acceleration a_{y} increases, the roll stiffness distribution shifts toward the front axle 16F. In addition, when the processing proceeds to step S108 because the lateral acceleration a_{y} is lower than the threshold value a_{yt} but the vehicle stability control is abnormal, the controller 30 may calculate the increase amount M_{rf} by multiplying the lateral acceleration a_{y} itself by a designated gain.

$${M}_{rf} = γ ( {a}_{y} - {a}_{yt} ) \qquad ( 5 )$$

Further, the control process according to the present embodiment may include a “distribution process”. In an example involving the distribution process, the controller 30 calculates the required control forces F_{fli}, F_{fri}, Fᵣₗᵢ, and Fᵣᵣᵢ for the four wheels 14 so as to reduce, on the side of the rear axle 16R, a roll moment having the same magnitude as the roll moment increased on the side of the front axle 16F.

To be more specific, Mᵣᵣₗ and Mᵣᵣᵣ are decrease amounts in roll moments generated at the two wheels 14RL and 14RR on the side of the rear axle 16R (first axle), respectively. The increase amount M_{rf} and the two decrease amounts Mᵣᵣₗ and Mᵣᵣᵣ have a relation expressed by the following Equation 6. That is, the decrease amounts Mᵣᵣₗ and Mᵣᵣᵣ are determined such that the sum of the decrease amount Mᵣᵣₗ and the decrease amount Mᵣᵣᵣ becomes equal to the increase amount M_{rf}. Therefore, according to Equation 4 expressed above, the roll moment having the same magnitude as the roll moment increased on the side of the front axle 16F is decreased on the side of the rear axle 16R.

$${M}_{rf} = {M}_{rrl} + {M}_{rrr} \qquad ( 6 )$$

Additionally, with respect to the distribution process, broadly speaking, the ratio of each of the decrease amounts Mᵣᵣₗ and Mᵣᵣᵣ to the increase amount M_{rf} may be freely set. However, the ratio may be determined using techniques described in the following Section 3 regarding “Specific Examples of Distribution Process”.

### <Step S110>

In step S110 after step S106 or S108, the controller 30 controls the actuators 26FR, 26RL, and 26RR for the three wheels 14 based on the required control forces F_{fli}, F_{fri}, Fᵣₗᵢ, and Fᵣᵣᵢ calculated in step S106 or S108.

Specifically, in step S110, the controller 30 converts the required control forces F_{fli}, F_{fri}, Fᵣₗᵢ, and Fᵣᵣᵢ into required control forces F_{fr}, Fᵣₗ, and Fᵣᵣ for the three wheels 14 having the actuators 26. For this conversion, for example, a technique described in JP 2023-047810 A can be used. The conversion using this technique is outlined as follows.

With respect to the conversion described above, the controller 30 first uses the following Equation 7 to convert the required control forces F_{fli}, F_{fri}, Fᵣₗᵢ, and Fᵣᵣᵢ into required values for three modes at gravity center. The three modes at gravity center are motion modes for a heave force, a roll moment, and a pitch moment acting on the gravity center 11 of the vehicle 10. The required values for the three modes at gravity center are a required heave force Fₕₜ, a required roll moment Mᵣₜ, and a required pitch moment Mₚₜ shown in Equation 7. In Equation 7, l_{f} and lᵣ are distances between the gravity centers of the front axle 16F and the rear axle 16R, respectively. In addition, the required roll moment Mᵣₜ includes the required roll moment Mᵣ for the vehicle roll control according to the present embodiment. It should be noted that the required values for the three modes at gravity center may include a required value for any vehicle behavior control other than the vehicle roll control.

$$[ \begin{matrix}{F}_{ht} \\ {M}_{rt} \\ {M}_{pt}\end{matrix} ] = [ \begin{matrix}1 & 1 & 1 & 1 \\ \frac{- {T}_{f}}{2} & \frac{{T}_{f}}{2} & \frac{- {T}_{r}}{2} & \frac{{T}_{r}}{2} \\ - {l}_{f} & - {l}_{f} & {l}_{r} & {l}_{r}\end{matrix} ] [ \begin{matrix}{F}_{fri} \\ {F}_{fli} \\ {F}_{rri} \\ {F}_{rli}\end{matrix} ] \qquad ( 7 )$$

With respect to the conversion described above, the controller 30 then uses the following Equation 8 to convert the required values for the three modes at gravity center into the required control forces F_{fr}, Fᵣₗ, and Fᵣᵣ for the three wheels 14, i.e., the required control forces for the three actuators 26.

$$[ \begin{matrix}{F}_{fr} \\ {F}_{rr} \\ {F}_{rl}\end{matrix} ] = {[ \begin{matrix}1 & 1 & 1 \\ \frac{- {T}_{f}}{2} & \frac{- {T}_{r}}{2} & \frac{{T}_{r}}{2} \\ - {l}_{f} & {l}_{r} & {l}_{r}\end{matrix} ]}^{- 1} [ \begin{matrix}{F}_{ht} \\ {M}_{rt} \\ {M}_{pt}\end{matrix} ] \qquad ( 8 )$$

In step S110, the controller 30 controls the actuator 26FR such that the vertical control force applied to the right front wheel 14FR becomes equal to the required control force F_{fr}. Similarly, the controller 30 controls the actuator 26RR such that the vertical control force applied to the right rear wheel 14RR becomes equal to the required control force Fᵣᵣ, and controls the actuator 26RL such that the vertical control force applied to the left rear wheel 14RL becomes equal to the required control force Fᵣₗ. By controlling the respective actuators 26FR, 26RR, and 26RL based on the required control forces F_{fr}, Fᵣₗ, and Fᵣᵣ converted from the required values for the three modes at gravity center in this way, desired behaviors including all of the roll, pitch, and heave are realized in the vehicle 10.

In addition, the control of the actuators 26 described above is applied to the actuators 26 configured to perform force (torque) control. Unlike this control example, in an example in which actuators 26 configured to perform position (angle) control are provided for the three wheels 14, the controller 30 may control the three actuators 26 as follows. That is, the controller 30 calculates position control amounts of the three actuators 26 that respectively satisfy the required control forces F_{fr}, Fᵣₗ, and Fᵣᵣ converted by Equation 8. Then, the controller 30 performs the position control of the three actuators 26 in accordance with the calculated position control amounts.

### <Effect>

As described above, according to the control process of the present embodiment, when the lateral acceleration a_{y} increases to the high acceleration range R2 beyond the low acceleration range R1, the roll stiffness of the front axle 16F (second axle) is increased. As a result, in the high acceleration range R2, the bias in the roll stiffness distribution can be reduced without depending on the technique of reducing the roll control gain (that is, while reducing the occurrence of a large roll according to the lateral acceleration a_{y}). Also, according to the present embodiment, when the lateral acceleration a_{y} is in the low acceleration range R1 but the vehicle stability control is abnormal, the roll stiffness of the front axle 16F (second axle) is increased. As a result, when the lateral acceleration a_{y} is in the low acceleration range R1 but the vehicle stability control is abnormal, unintended oversteer or understeer can be reduced by the control process executed to reduce the bias in the roll stiffness distribution, and the stability of the vehicle 10 can be improved.

Moreover, according to the distribution process included in the control process, the increase in the roll stiffness of the front axle 16F is executed based on the relations of Equations 4 and 6 (see step S108). That is, part of the control forces to be generated by the pair of left and right actuators 26RL and 26RR (first actuators) on the side of the rear axle 16R in order to realize the required roll moment Mᵣ is distributed to the actuator 26FR (second actuator) on the side of the front axle 16F. Broadly speaking, the control process may be executed so as to simply increase the roll moment generated on the side of the front axle 16F without being accompanied by the distribution process. In contrast, by including the distribution process, the bias in the roll stiffness distribution can be effectively reduced when the roll moment generated on the side of the front axle 16F is increased by the same amount, as compared with an example in which the distribution process is not included.

Moreover, according to the present embodiment, when the roll stiffness of the front axle 16F is increased by the control process, the FB control gain β with respect to the sprung mass roll velocity is increased (β₂>β₁). As a result, when the vehicle roll control is performed using the actuators 26 for the three wheels 14 with the control process, changes in the sprung mass roll velocity can be converged more quickly and the bias in the roll stiffness can be reduced.

Furthermore, according to the control process of the present embodiment, the increase in the roll stiffness of the front axle 16F in the high acceleration range R2 is executed based on the relation of Equation 5 (see step S108). That is, when the lateral acceleration a_{y} is higher, the increase amount M_{rf} becomes greater and the roll stiffness of the front axle 16F is increased. Therefore, the bias in the roll stiffness can be appropriately reduced in accordance with an increase in the lateral accelerations a_{y} in the high acceleration range R2.

### 3. Specific Examples of Distribution Process

First, a specific example EX1 of the distribution process (see step S108) will be described. In this specific example EX1, the controller 30 distributes, to the actuator 26FR (second actuator), part of the control force to be generated by the actuator 26RR (first actuator) of the right rear wheel 14RR of the rear axle 16R located on the same side as one wheel (right front wheel 14FR) of the front axle 16F having the actuator 26FR.

More specifically, as expressed by Equation 9, the decrease amount Mᵣᵣᵣ of the right rear wheel 14RR is set to be equal to the increase amount M_{rf}. Therefore, from the relation of Expression 5 expressed above, the decrease amount Mᵣᵣₗ of the left rear wheel 14RL becomes 0 as expressed by Expression 10. As a result, part of the control force to be generated by the actuator 26RR of the right rear wheel 14RR (i.e., the control force according to the decrease amount Mᵣᵣᵣ) is distributed to the actuator 26FR as a control force according to the increase amount M_{rf}.

$${M}_{rrr} = {M}_{rf} \qquad ( 9 )$$

$${M}_{rrl} = 0 \qquad ( 10 )$$

From the viewpoint of preventing the vehicle 10 from overturning, a lower sprung mass gravity center height is better. According to the specific example EX1, it is possible to distribute, to the second actuator (e.g., actuator 26FR), part of the control force to be generated by the first actuator (e.g., actuator 26RR) on the side of the rear axle 16R while preventing the force in the heave direction from being generated. More specifically, according to the distribution of the specific example EX1, the pitch behavior is generated in accordance with the output of the roll moment, but no force is generated in the heave direction. Therefore, it is possible to reduce the behavior in which the sprung mass gravity center height increases, which is the behavior that may lead to the overturning. Thus, according to the specific example EX1 (the same applies to specific examples EX2 and EX3 described below), it is possible to prevent the overturning while reducing unintended oversteer or understeer in the high acceleration range R2. In addition, the decrease amounts Mᵣᵣₗ and Mᵣᵣᵣ may be determined from Equation 5 while satisfying the relation of “decrease amount: Mᵣᵣᵣ>Mᵣᵣₗ” instead of the specific example EX1. The effect of reducing heave can be obtained also by this relation.

Next, in the specific example EX2, the decrease amounts Mᵣᵣₗ and Mᵣᵣᵣ are set as follows in accordance with the sign of the increase amount M_{rf}. That is, the downward control force Fᵣₗ or Fᵣᵣ of the control forces Fᵣₗ and Fᵣᵣ of the first actuators configured to generate the roll moment on the side of the rear axle 16R corresponds to a force acting in a direction to lower the sprung mass gravity center height and also corresponds a force acting in a direction to prevent overturning of the vehicle 10 due to the action of the lateral accelerations a_{y}.

Accordingly, in the specific example EX2, when the increase amount M_{rf} is negative, the controller 30 sets the decrease amounts Mᵣᵣₗ and Mᵣᵣᵣ in accordance with the relations of Equations 9 and 10 described above. On the other hand, when the increase amount M_{rf} is positive, the controller 30 sets the decrease amounts Mᵣᵣₗ and Mᵣᵣᵣ in accordance with the relations of the following Equations 11 and 12, that is, the relations opposite to the relations of Equations 9 and 10. This makes it possible to realize the distribution process that can further effectively lower the sprung mass gravity center height. In addition, the decrease amounts Mᵣᵣₗ and Mᵣᵣᵣ may be determined from Equation 5 while satisfying the relation of “decrease amount: Mᵣᵣₗ>Mᵣᵣᵣ” instead of the specific example EX2. The effect of lowering the sprung mass gravity center height can be obtained also by this relation.

$${M}_{rrl} = {M}_{rf} \qquad ( 11 )$$

$${M}_{rrr} = 0 \qquad ( 12 )$$

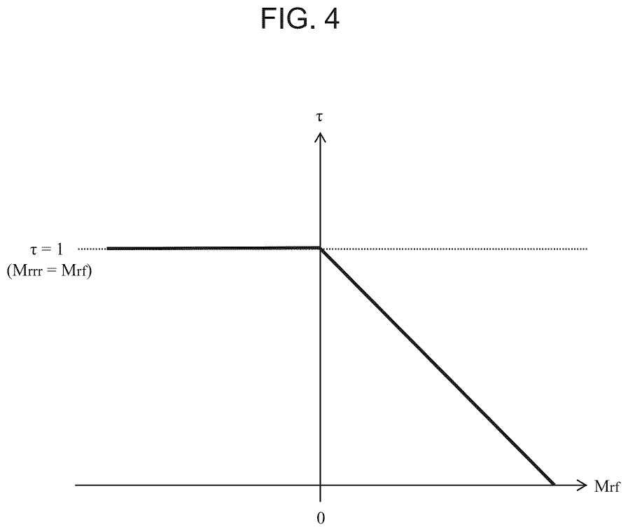

The distribution process that involves considering the sign of the increase amount M_{rf} is not limited to the specific example EX2, and may be executed as in the following specific example EX3. FIG. 4 is a diagram used to describe the specific example EX3 of the distribution process. That is, in the distribution process in which the sign of the increase amount M_{rf} is considered, when the increase amount M_{rf} is positive, the decrease amount Mᵣᵣₗ according to the increase amount M_{rf} having the same absolute value may be set to be larger than when the increase amount M_{rf} is negative. To be specific, the decrease amounts Mᵣᵣₗ and Mᵣᵣᵣ may be set in accordance with the relation shown in FIG. 4, for example. In FIG. 4, τ is a ratio of (the absolute value of) the decrease amount Mᵣᵣᵣ to (the absolute value of) the increase amount M_{rf}. Therefore, when the ratio τ is 1, the decrease amount Mᵣᵣᵣ is equal to the increase amount M_{rf}. In the example shown in FIG. 4, when the increase amount M_{rf} is negative, the ratio τ is constant at 1, that is, the decrease amount Mᵣᵣₗ is constant at 0. On the other hand, when the increase amount M_{rf} is positive, the ratio τ linearly decreases from 1 to 0 with an increase in the increase amount M_{rf}. Accordingly, the decrease amount Mᵣᵣₗ linearly increases from 0 to the same magnitude as the increase amount M_{rf}. The effect of lowering the sprung mass gravity center height can be obtained also by the specific example EX3.

### 4. Other Embodiments

In the flowchart shown in FIG. 3, when the vehicle stability control is normal but the lateral acceleration a_{y} is in the high acceleration range R2, the control process using Equation 4 is executed. Instead of this example, when the vehicle stability control is normal, the process for the normal time using Equation 2 may be executed regardless of the level of the lateral acceleration a_{y}, and, only when the vehicle stability control is abnormal, the control process may be executed.

Moreover, with respect to the calculation of the required roll moment Mᵣ, a feedback term for the time derivative of the lateral acceleration a_{y} may be used instead of the feedback term for the sprung mass roll velocity (see Equation 1 or 3). Also, similarly to the example of the sprung mass roll velocity, when the roll stiffness of the front axle 16F is increased by the control process, a feedback control gain for the time derivative may be increased.

Furthermore, in the example shown in FIG. 1, the suspension 20FL for the left front wheel 14FL is a non-active suspension that does not have the actuator 26. Instead of this example, the suspension 20FR for the right front wheel 14FR may be a non-active suspension. In addition, unlike the example shown in FIG. 1, the front axle 16F may be the “first axle” and the rear axle 16R may be the “second axle”. In this example, the suspension 20RL or 20RR on the side of the rear axle 16R is a non-active suspension.

What is claimed is:

1. A vehicle behavior control apparatus, comprising:
a variable roll stiffness device configured to change roll stiffness of a first axle being one of a front axle and a rear axle of a vehicle and roll stiffness of a second axle being another of the front axle and the rear axle; and
a controller configured to:
control the variable roll stiffness device so as to increase the roll stiffness of the first axle in accordance with a lateral acceleration acting on the vehicle in at least a low acceleration range of ranges of the lateral acceleration, and
execute a control process of controlling the variable roll stiffness device so as to increase the roll stiffness of the second axle when the lateral acceleration increases to a high acceleration range beyond the low acceleration range, or a vehicle stability control for reducing at least one of oversteer and understeer of the vehicle is abnormal.

2. The vehicle behavior control apparatus according to claim 1, wherein
the variable roll stiffness device includes:
a pair of left and right first actuators configured to apply control forces in a vertical direction to left and right wheels of the first axle; and
a second actuator configured to apply a control force in the vertical direction to one wheel of the second axle,
the controller is further configured to calculate a required roll moment according to the lateral acceleration, and
the control process includes a distribution process of distributing, to the second actuator, part of control forces to be generated by the pair of left and right first actuators to realize the required roll moment.

3. The vehicle behavior control apparatus according to claim 2, wherein
in the distribution process, the controller is further configured to distribute, to the second actuator, part of a control force to be generated by one of the pair of left and right first actuators that is provided for one of the left and right wheels of the first axle located on a same side as the one wheel of the second axle.

4. The vehicle behavior control apparatus according to claim 2, wherein
the required roll moment includes a feedback term for roll velocity of a sprung mass of the vehicle,
the feedback term includes a feedback control gain with respect to the roll velocity, and
the controller is further configured to select a greater feedback control gain when the lateral acceleration increases to the high acceleration range beyond the low acceleration range or the vehicle stability control is abnormal, compared to when the lateral acceleration is in the low acceleration range and the vehicle stability control is normal.

5. The vehicle behavior control apparatus according to claim 1, wherein
in the control process, the controller is further configured to control the variable roll stiffness device so as to increase the roll stiffness of the second axle when the lateral acceleration increases.
